(19) United States
(12) Patent Application Publication
(10) Pub. No.: US 2013/0254007 A1
(43) Pub. Date: Sep. 26, 2013

(54) Flash Sale Systems

(71) Applicant: Oliver N. Cockcroft, Los Gatos, CA (US)

(72) Inventor: Oliver N. Cockcroft, Los Gatos, CA (US)

(73) Assignee: eBay Inc., San Jose, CA (US)

(21) Appl. No.: 13/427,528

(22) Filed: Mar. 22, 2012

(51) Int. Cl. G06Q 30/06; G06Q 30/02

(52) U.S. Cl. 705/14.25; 705/26.1; 705/14.53

(57) ABSTRACT

An apparatus and method are disclosed for receiving the identities of a plurality of users that register to be notified when a flash sale occurs. The identities of the plurality of users are ranked in a queue. When one of the plurality of users purchases a product in a flash sale, the rank of the user in the queue is improved. Variable item price discounts may be offered to users in a flash sale based on rank or based on demand (or lack thereof). If the item is a limited inventory item, discounts may be offered to the highest ranking members. Flash sales may be created based on comparison of registered user product preferences and product inventory.

The present application relates generally to systems and methods for electronic commerce, and in one specific example, to systems and methods for making electronic commerce purchases.

### BACKGROUND

In publication systems such as an electronic commerce marketplace, a user cart navigate within the marketplace to obtain information about items (e.g., goods or services) being offered for sale and to purchase one or more of those items. Goods and services in some instances may be offered at a discount for a period of time. Such instances may be referred to as flash sales and may be either of the buy-it-now type or auction type.

### BRIEF DESCRIPTION OF THE DRAWINGS

Some embodiments are illustrated by way of example and not limitations in the figures of the accompanying drawings.

FIG. 1 illustrates a network diagram depicting an exemplary client-server system according to some embodiments.

FIG. 2 illustrates a block diagram of additional details of applications included in the client-server system of FIG. 1.

FIG. 3A illustrates a block diagram of databases useful in various embodiments.

FIG. 3B illustrates a block diagram showing modules included in the flash sales applications of the exemplary client-server system of FIG. 1

FIG. 4A illustrates a user interface that may be used to notify a user of a flash sale.

FIG. 4B illustrates an exemplary flow diagram presenting a flash sale notification to a user.

FIGS. 5A and 5B illustrate profile and a method for creating a user profile for flash sales.

FIGS. 6A and 613 illustrate methods useful in implementing various embodiments discussed herein.

FIG. 7 shows a diagrammatic representation of a machine in the example form of a computer system within which a set of instructions for causing the machine to perform any one or more of the methodologies discussed herein may be executed.

The headings provided herein are for convenience only and do not necessarily affect the scope or meaning of the claimed embodiments of the disclosed subject matter. The same or similar reference numerals have been used to indicate the same or similar features in the figures, unless otherwise indicated.

### DETAILED DESCRIPTION

A sale of merchandise at a discount for a given period of time is sometimes referred to as a flash sale. In flash sales, a user typically opts in to buy an item, and can miss the sale of an item because other people purchased all the inventory of the item before the user was able to make a purchase. For a flash sale, users may tend to opt-out of buying an item rather than opting-in to buy it. Users may decide to opt-in if they are given more opportunities to buy as they purchase more of the items offered for sale at flash sales or otherwise.

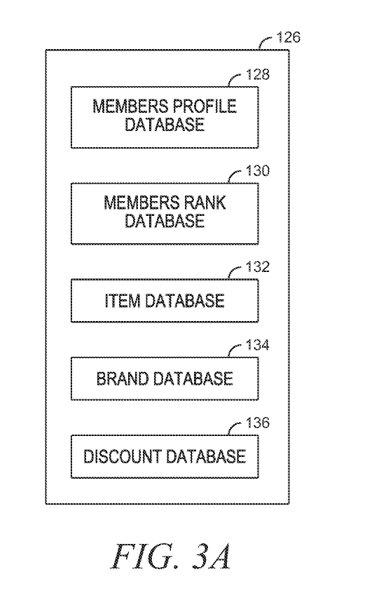

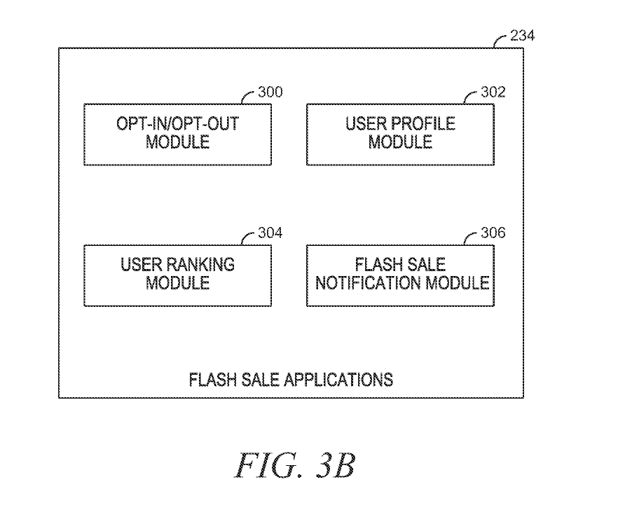

Users may be able to opt-in, sometimes referred to as registering to participate in the flash sale. Having opted-in or registered, a user may be referred to herein as a “member” or shopper.” In so doing, the user may create a profile that indicates which type, brand, and size of item the user desires to purchase. In some cases, the profile may be referred to as a wish list. When those items are offered in a flash sale, the system may generate queues of users who may purchase particular items at flash sales, based on the user profiles. In another embodiment, the items that are offered in a flash sale may be based at least in part on the items in the wish list. Notifications may be sent to users as they are selected for the flash sale. The notifications of flash sales may specify the opt-out time period along with other information such as a discount. Discounts, as applied to items and/or to individual flash sales, may be stored in discount database 136, as discussed below with reference to FIG. 3A. In one embodiment the user may opt-out of the sale via the notification. In another embodiment the system may ask the user to log in and opt-out.

Users may also be ranked based on flash sale purchase activity, such that users who purchase more in the flash sales are given a higher rank. For certain sales with limited inventory, the inventory may be offered to users by rank, with each user given an opt-out period, which may be variable, in which to decline the offer to purchase the item. The variable opt-out period may in one embodiment depend on the demand for the item, such as the number of users in the queue for the item.

If the user does not decline during the opt-out period, the user's payment account, for example PayPal®, will be charged and the user will receive the item. A return policy may be built into the system to allow for purchasers to return or relist the item for sale in the event they intended to opt-out but failed to do so. Users who purchase items may then have their rank increased.

Variable discounts may be offered to users based on rank or based on demand (or lack thereof). For example, if users tend to opt-out of purchasing an item, a larger discount may be offered to move the inventory. If the item is a limited inventory item, discounts may be offered to the highest ranking members as a reward.

New users who begin with a low ranking may still have an opportunity to purchase items by being placed in the queue strategically. For example, new users may have priority to purchase items above those who opt-out and then try to change their mind and re-opt-in. Users who re-opt-in may also be targeted with lesser demanded items as a way to engage those users and allow them to build up their rank.

The following description is presented to enable any person skilled in the art to create and use a computer system configuration and related method and article of manufacture to engage in flash sales as discussed above. Various modifications to the example embodiments will be readily apparent to those skilled in the art, and the generic principles defined herein may be applied to other embodiments and applications without departing from the spirit and scope of the embodiments of the invention. Moreover, in the following description, numerous details are set forth for the purpose of explanation. However, one of ordinary skill in the art will realize that the embodiments may be practiced without the use of these specific details. In other instances, well-known structures and processes are shown in block diagram form in order not to obscure the description of the embodiments with unnecessary detail. Thus, the present disclosure is not intended to be limited to the embodiments shown, but is to be accorded the widest scope consistent with the principles and features disclosed herein.

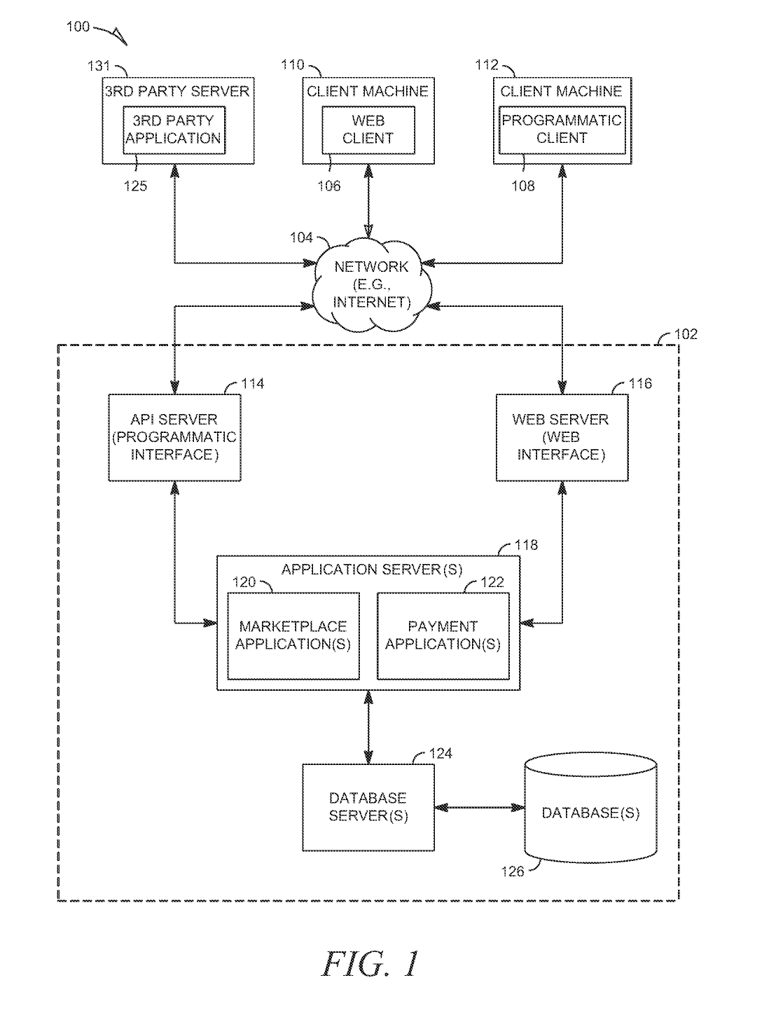

FIG. 1 illustrates a network diagram depicting an exemplary client-server system 100 for providing selective electronic commerce marketplace checkout according to some embodiments. A networked system 102 is illustrated in the example form of a network-based publication system that provides server-side functionality, via a network 104 (e.g., the Internet or Wide Area Network (WAN)) to one or more clients. FIG. 1 further illustrates, for example, a web client 106 (e.g., a browser, such as the Internet Explorer browser developed by Microsoft Corporation of Redmond, Wash.), and a programmatic client 108 executing on respective client machines 110 and 112. In one embodiment, the publication system comprises a marketplace system. In another embodiment, the publication system comprises other types of systems such as, but not limited to, a social networking system, an information retrieval system, and the like.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, are shown to be coupled to one or more database servers 124 that facilitate access to one or more databases 126.

The marketplace applications 120 may provide a number of marketplace functions and services to users that access networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present disclosure is of course not limited to such an architecture, and may equally well find application in a distributed, or peer-to-peer, architecture system, for example. The various marketplace and payment applications 120 and 122 may also be implemented as standalone software programs, which do not necessarily have networking capabilities.

The web client 106 accesses the various marketplace and payment applications 120 and 122 via, the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay® Inc., of San Jose, Calif.) to enable users who are sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace, or payment functions that are supported by the relevant applications of the networked system 102.

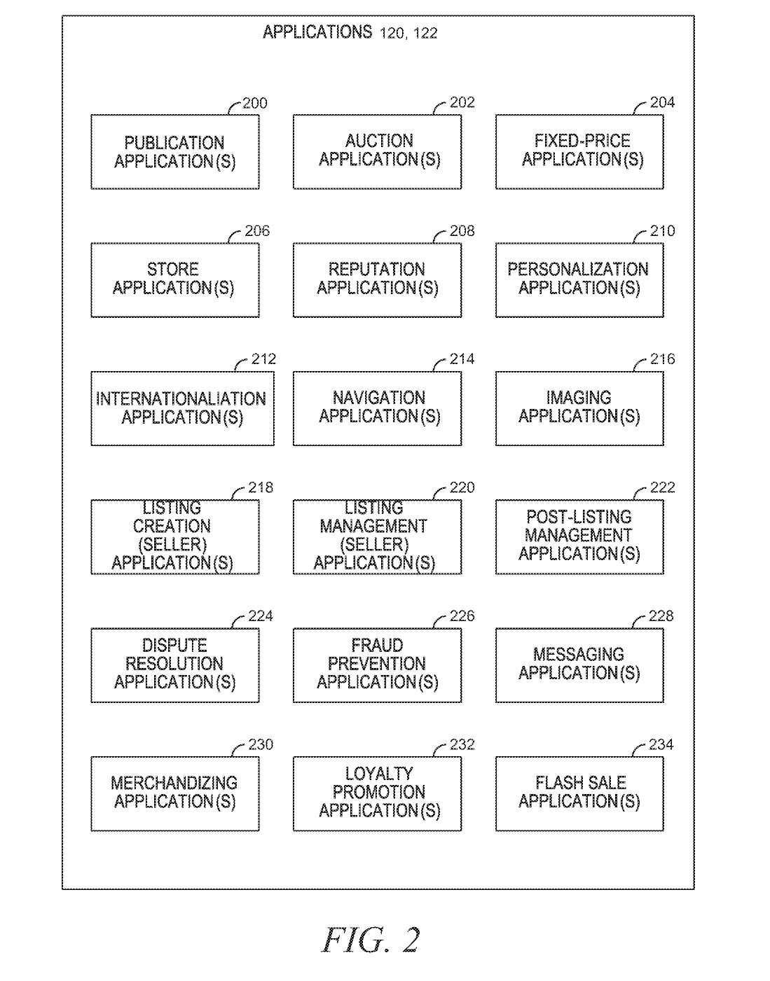

FIG. 2 illustrates a block diagram of additional details of applications 120 and 122 according to some embodiments. Applications 120 and 122 may be hosted on dedicated or shared server machines (not shown in FIG. 2) that are communicatively coupled to enable communications between server machines. The applications 120 and 122 themselves are communicatively coupled (e.g. via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124 of FIG. 1.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction application(s) 202 which support auction-format listing and price setting mechanisms (e.g., English, Dutch, Vickrey, Chinese, Double, reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now® (BIN) technology developed by eBay® Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users that transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings that are available via the networked system 102 as visually informing and attractive as possible, the marketplace and payment applications 120 and 122 may include one or more imaging applications 216 utilizing images that users may upload for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to, for example, a third-party mediator or arbitrator.

A number of fraud prevention applications 226, known independently in the art, implement fraud detection and prevention mechanisms to reduce the occurrence of fraud within the networked system 102.

Messaging applications 228 are responsible for the generation and delivery of messages to users of the networked system 102, such messages including, for example, advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and may be offered a reward for which accumulated loyalty points can be redeemed.

Flash sale applications 234 support various flash sale functions that allow users to opt-in and opt-out of flash sales via the networked system 102. The flash sale applications 234 may also be used by the networked system 102 to monitor and track the user purchase of merchandise in flash sales, to provide user ranking based on merchandise purchased by the users, and to notify users of flash sales.

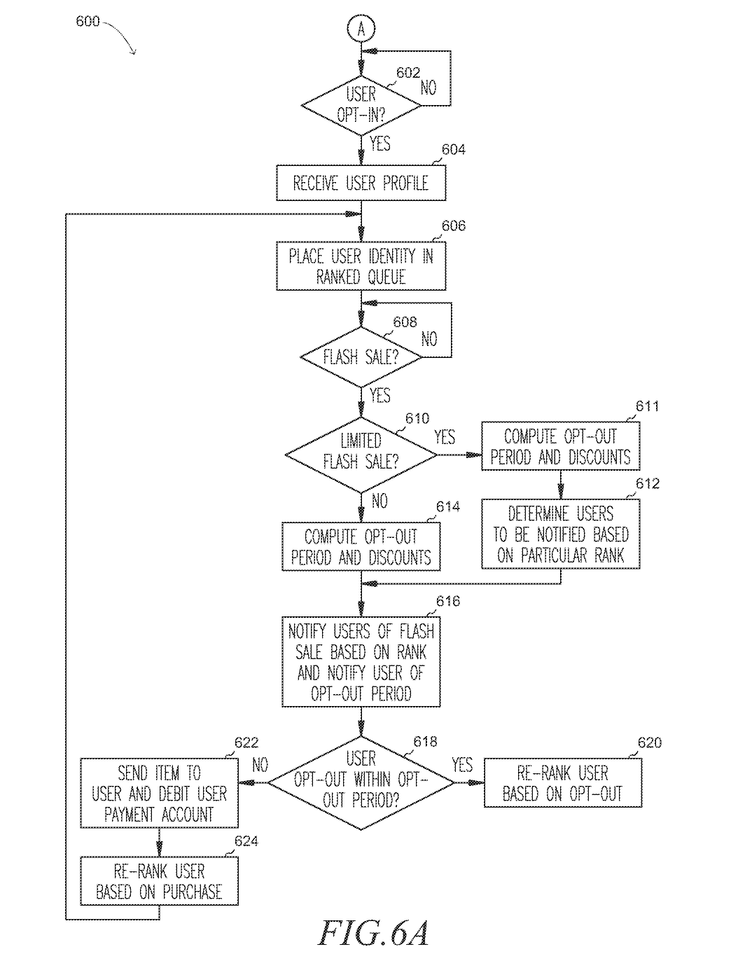

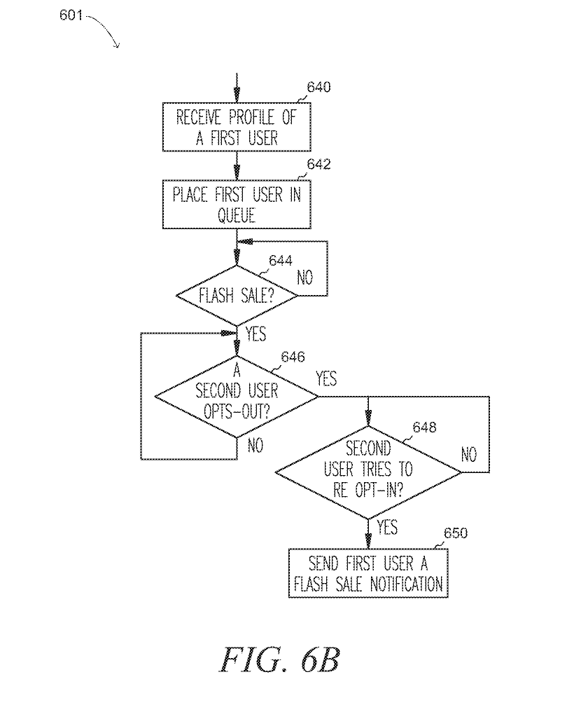

FIG. 3A illustrates databases 128, 130, 132, 134, and 136 useful in an embodiment. The databases 128-136 are illustrated as being in database 126 of system 102 seen in FIG. 1. However those of ordinary skill in the art will recognize that these databases 128-136 could be located elsewhere and be available to system 102. As shown in FIG. 3A, database 128 is a members' profile database which may contain profiles generated by members, indicating their preferences of items, brands, sizes, and other attributes. Members' rank database 130 may include information that provides ranks of members. Members' item database 132 may include items, and may include item sizes, entered into inventory by sellers. The items and sizes may be linked to the respective member or members who entered them in their profile. Brand database 134 may include brands of the items. The brands may be linked to the respective member or members who entered the brands in their profile, and may also be linked to the items. Discount Database 136 may include discounts offered on various items. Discounts may be set by sellers or may be computed as discussed below with reference to FIG. 6A.

FIG. 3B illustrates a block diagram showing modules included in the flash sale applications 234 according to some embodiments. The flash sale applications 234 include an opt-in/opt-out module 300, user profile generation module 302, user ranking module 304, and flash sale notification module 306. User opt-in/opt-out module 300 may receive user opt-ins and opt-outs for flash sales, provide functions such as, inter alia, determining whether a given user is opted-in or opted-out at any given time, and may generate queues of opted-in users for the members' rank database 130 (FIG. 3A). Such queues may in some instances be based on ranking as discussed below.

User profile generation module 302 may provide for storing user-created preference profiles in conjunction with a user opting-in for a flash sale.

User ranking module 304 may rank users based on the time a user opts-in. The ranking module 304 may improve a user's rank based on a user's flash sale purchase activity, such that users who purchase more in flash sales are given a higher rank. Ranking module 304 may detect a member opting-out of a flash sale and may negatively adjust the member's ranking based on the opt-out. The negative adjustment may be decrementing rank one position for each opt-out, or other type of adjustments known to those of ordinary skill in the art. Ranking module 304 may also detect a member opting-back-in and may positively adjust the member's rank based on the opt-back-in. Queues based on rank may be generated on the user ranking module 304.

Flash sale notification module 306 may present flash sale notification to users who have opted in or who otherwise have shown an interest in knowing about flash sales at which certain types and/or brands of merchandise, or non-specified types of merchandise, are offered. A flash sale notification module 306 may be configured to identify an item to be offered at a flash sale, and a flash sale time. The flash sale notification module 306 may in some embodiments aid in setting discounts and/or periods for opting out. In some embodiments, a flash sale may be pre-scheduled by a seller or may be initiated based on a pre-defined trigger which is implemented by the flash sale notification module 306. In one embodiment the flash sale notification module 306 is a memory storage device storing flash sale-specific information that is used by other modules to implement flash sale timing and configuration according to the information stored in the ranking module 304 and/or the flash sale notification module 306.

In some embodiments the flash sale notification module 306 is a control module that receives the inputs of the seller and configures the system 102 to implement and enable an in-store or flash sale. To illustrate, a seller may schedule a flash sale for a particular item to begin at a certain time or may specify that a flash sale be triggered if a specified number of items remain in inventory or if an item is discontinued or otherwise no longer considered a top selling item. In another embodiment, items in members' item database 132 of FIG. 3A may be compared against items in member database 128 to determine the number of items that match in the two databases 132 and 128, and the information gained from the comparison may be used to determine items with respect to which a flash sale is offered. In some instances, a flash sale may be spontaneously initiated by the seller by providing instruction to the flash sale notification module 306 to send notifications to shoppers. Some sellers may initiate a flash sale in response to receiving a request from a customer requesting that a seller offer a flash sale for a particular item. Such notifications may be based on the ranking of user ranking module 304. Other functions discussed above with respect to flash sales may also be included in flash sale applications 234 (FIG. 2).

Although modules 300-306 are shown as distinct modules in FIG. 3B, it should be understood that modules 300-306 may be implemented as fewer or more modules than illustrated. It should also be understood that any of modules 300-306 may communicate with one or more components included in networked system 102 as illustrated in FIG. 1, such as database servers 124, API server 114, or web server 116.

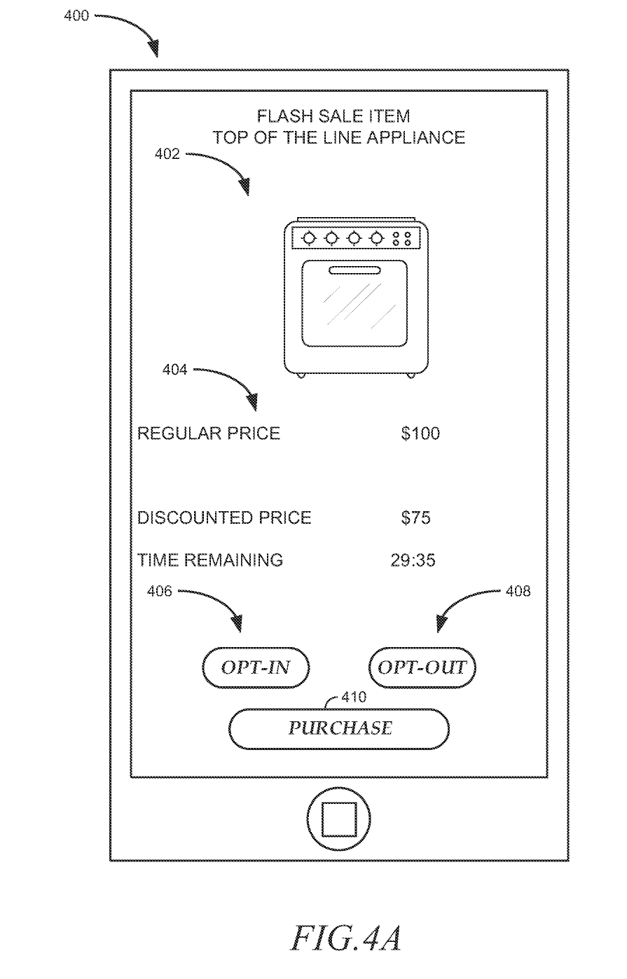

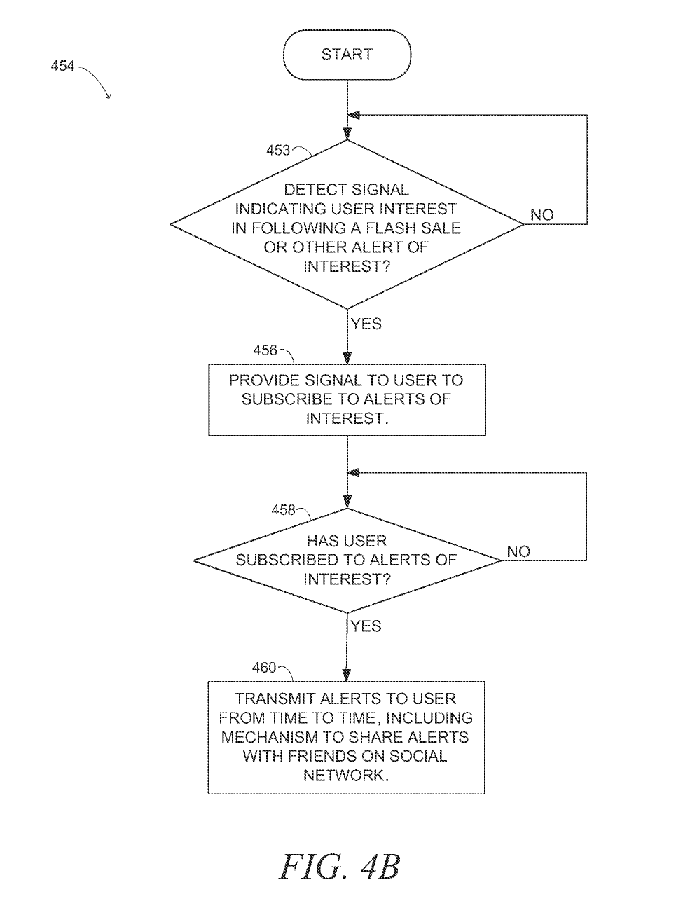

FIG. 4A illustrates a portion of a user interface including flash sale interface 400, according to an example embodiment. The interface 400 may be on a mobile device such as a smart phone or tablet, or on a stationary device, such as a computer. In either case the interface 400 may be provided by a server to a client. The flash sale interface 400 includes a description 402 of the item that is the subject of the flash sale. As depicted, the description 402 includes a name of the item, an image of the item and, if the flash sale is in a physical store instead of at an ecommerce marketplace, and an indication of an in-store location of the item. Additional information may be accessible or presented to the user as part of the description 402. The electronic marketplace comprises a network-based transaction facility that directly offers for sale or hosts offers to sell from third parties. Accordingly, an item that is the subject of the flash sale at the electronic marketplace may be provided by one or more manufacturers, distributors, vendors, sellers, retailers, or the like.

A flash sale price information portion 404 of the flash sale interface 400 may include price information about the flash sale being conducted. The flash sale price information portion 404 may include an indication of the regular price of the item, the discounted price of the item, and an amount of time remaining in the flash sale.

An opt-out icon 408 is a selectable icon that, when selected, allows the user to opt-out of the flash sale. The opt-in icon 406 is a selectable icon that, when selected, allows the user to opt-in or to opt back in after opting-out, depending on the embodiment. The purchase icon 410 is a selectable icon which, when selected, indicates that the user desires to purchase an item.

In some embodiments, a flash sale interface 400 may be presented to registered or opt-in participants before the flash sale begins. The flash sale interface 400 may include the description 402 and the flash sale price information portion 404. The flash sale information portion 404 may include an indication of the regular price of the item and the discounted price of the item, and an amount of time remaining to opt-out should the user elect to do so by selecting opt-out icon 408. The price may be modified as considered appropriate by the seller or by the system on which the flash sale is undertaken.

In one embodiment, the user may opt-in or otherwise indicate that the user is interested in being notified of flash sales. This may be done by selecting opt-in icon 406 or otherwise, such as sending an email if sending emails is a means for opting-in. As an example, in FIG. 4B, method 454 indicates an implementation of sending flash sale notifications to users. As is seen at decision block 453, the method detects a signal indicating a user is interested in following a flash sale. If such a signal is detected, the Yes path is taken from decision block 453 and, as at block 456, a signal is provided to the user to enable the user to subscribe to notifications of interest. Decision block 458 checks to determine whether the user has subscribed to follow any events of interest. If the user has so subscribed, then the Yes path is take from decision block 458 and, at block 460, the method sends notices to the user from time to time, as they occur. In another embodiment, the method of FIG. 4B may include a mechanism to allow the user to share notifications with friends on a social network. An additional mechanism to allow the friend to access the ecommerce marketplace to purchase commercial items for sale, at a flash sale or otherwise, can also be included at block 460. Mechanisms discussed herein may simply be a link to the appropriate ecommerce marketplace function page.

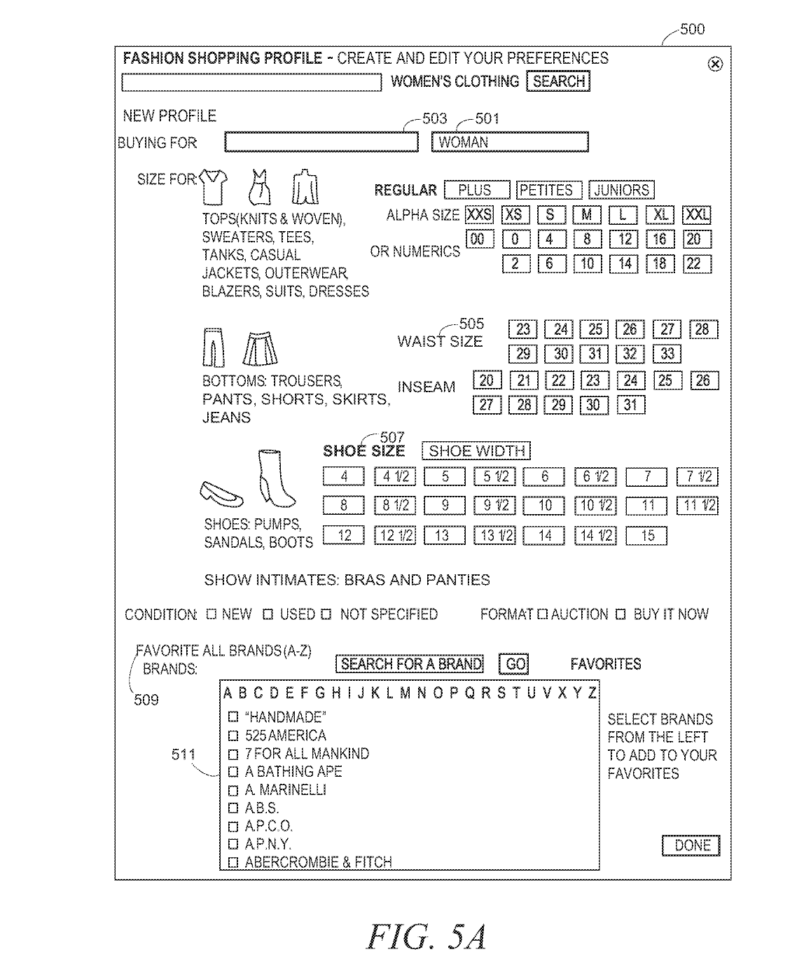

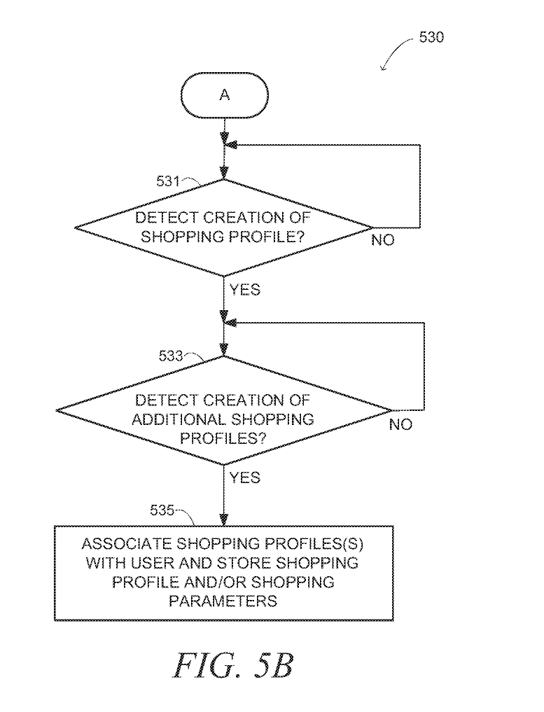

In one embodiment, a user who opts-in may create a profile, sometimes called a “wish list,” that indicates the type of flash sale items the user would like to be notified of. One embodiment of this profile creation can be seen in FIG. 5A. When a user clicks on a Create Profile on a user interface (not shown in FIG. 5A) presented to the user, the system may, in response, open up display space such as, in one embodiment, the window or user interface (“UI”) 500 seen in FIG. 5A. If the UI 500 shown in FIG. 5A is presented to a user as a result of activating a control from a web page displaying women's fashion items, a text box 501 may be prefilled with the value “Women.” In the present example of FIG. 5A, the user, activating a control from a web page displaying women's fashions, has selected Dresses as a first type of item, and is creating a shopping profile for the listings of dresses in the context of the on-line trading system. If the user were activating a control from a web page displaying men's fashions, the system defaults to “Men.” In the current embodiment there may be a list of brands 511 which may be used for choosing brands for a shopping profile. The user can enter a name for a shopping profile for current or subsequent use. The user may give the shopping profile a name, as at a profile name box 503. For example, the user could name a shopping profile “Diana's Every Day Brands,” indicating a class of items for shopping for every day occasions, and can enter such selected shopping parameters as waist size, shoe size, and favorite brands, which can then be saved. Alternatively, the entire shopping profile can be saved. There could be specified places 505, 507, 509, in the shopping profile for waist size, shoe size, and favorite brands, respectively. Such profile(s) may be viewed as user preference profiles used to indicate the type of flash sale for which the user would like to receive notification. The user profiles may be stored in members' profile database 128 of FIG. 3A. The items, brands, and sizes may be stored in the members' item database and brand database 132, 134, respectively, of FIG. 3A that were discussed above. Similarly, as discussed earlier, members may be ranked and their ranks may be stored in members' rank database 130.

While it is apparent to one of ordinary skill in the art upon reading and understanding the disclosure provided herein how to implement the above shopping profile embodiment, the following is provided as additional teaching. FIG. 5B illustrates a flow chart for a method 530 for creating shopping profiles, in accordance with an example embodiment. The method may be performed by processing logic that may comprise hardware (e.g., dedicated logic, programmable logic, microcode, etc.), software (such as run on a general purpose computer system or a dedicated machine), or a combination of both. Referring to FIG. 5B, the method 530 at decision point 531 checks to determine whether a user has created a shopping profile. If the method detects a creation of a shopping profile, it takes the Yes path to decision point 533. If not, it continues checking for an appropriate time as determined by the system designer. At decision point 533, the method checks for the detection of additional shopping profiles. If the creation of additional shopping profiles is detected, up to the maximum number of shopping profiles for which the system may be designed, the method at block 535 associates the shopping profiles with the user and stores the shopping profile. Alternatively, the system may store only the selection shopping parameters of the shopping profile. If, on the other hand, no additional shopping profiles are detected at decision point 533, the method may take the No path and continue to check for an appropriate period of time before performing the storage step at block 535.

FIG. 6A illustrates a method 600 useful as, or as part of, an embodiment. Discussion of the method 600 refers to one user, but those of ordinary skill in the art will understand that the method 600 can be used for multiple users, such as for example, implementing the method 600 in parallel.

At decision point 602, sellers may have previously entered items into inventory. The method may then watch for a user to opt-in or otherwise register to be notified of flash sales. When a user opt-in is detected, such as at the Yes decision of decision point 602, the user creates a user preference profile which is received at step 604. The user may at step 606 be placed in a queue to receive notifications of flash sales. In one embodiment, users may initially be ranked in the queue based on their time of opt-in or registration).

At decision box 608, the method 600 determines whether a flash sale has been created. If the Yes decision is taken, the method may check, at decision point 610, to see whether the flash sale is a limited flash sale such as, for example, a flash sale with limited inventory for sale. If the Yes decision path is taken, the method may compute, at step 611, an opt-out period for the flash sale and may also compute discounts. Discounts may be computed by detecting whether the items in a given flash sale have been, or are being, sold successfully. If the items are not being sold, or are being sold at less than a desired rate, a discount, or a further discount, may be computed and the item offered at the computed discounted price. Alternatively, the discount may be pre-set by the seller or by some other entity or system. The discounts may be stored in discount database 136 of FIG. 3A. The method 600 may at step 612 detect users that are to be notified, which may be based on the user's particular rank in the queue. In one embodiment, for a limited inventory flash sale, the users that will be notified may be a number of users with the highest rank in the queue, depending on the decision of the seller and in some instances the amount of product in inventory. In one embodiment, decision point 610 and steps 611 and 612 may be skipped. In an alternate embodiment, the system may search the ecommerce system inventory of items against the items, sizes, and brands in the item database 132 and/or the brand database 134, which were listed in one or more of the profiles in members profile database 128 (FIG. 3A). Based on detecting items and brands in the inventory corresponding to a sufficient number of items, sizes and brands in the foregoing three databases, a flash sale of one or more detected item may be created. One of ordinary skill in the art will recognize that the sufficient number will be determined based on the business plan of the ecommerce system or of the sellers.

If the No decision is taken at decision point 610, step 614 may compute opt-out period and discounts, as at step 611, and at step 616 the users may be notified based on rank, which may be different than the particular rank at step 612. The users notified may be based on their rank in the queue; higher ranked users may be notified of a particular flash sale and users below that rank may not be notified of the flash sale. If decision point 610 and steps 611 and 612 were taken, step 614 may be skipped.

At this point the flash sale may begin, including counting down the opt-out period. Decision point 618 checks to determine whether the user has opted-out during the opt-out period. If the Yes decision is taken, then the method 600 may at step 620 negatively adjust the ranking for the given user based on the opt-out. In an alternate embodiment, the method 600 may simply end at step 620 without adjusting the ranking. If the No decision is taken at decision point 618, the item may be considered purchased, and at step 622, the item is sent to the user and the user's payment account, such as PayPal®, is debited for the amount of the purchase. In another embodiment, the purchase may not be deemed consummated until the user actually selects the purchase icon 410 of FIG. 4A. Continuing, at step 624, the user's rank in the queue may be improved based on the purchase at step 622. This may be done based on any type of ranking system that is decided on by the implementer of the embodiment. In one embodiment, a user may be advanced a certain percentage of the way up the queue based on making a purchase. In another embodiment, the user's queue position, or rank, improvement may be based on the amount of money paid for purchases. The method may then begins again at step 606.

FIG. 6B illustrates a method 601 of placing a first user in the user queue strategically based on other than the user's first-time entry into the queue. In one embodiment, the first user's preference profile is received at step 640 and the user is placed in the flash sale queue at 642. The beginning of a flash sale may be detected at decision point 644. These three steps, 640, 642, 644 may be the same as or equivalent to steps 602, 604, and 606 in FIG. 6A. In one embodiment, the first user is not sent a notification of the flash sale because the user's rank rendered the user one rank below the final user to be sent a notification. If the Yes decision is taken at decision point 644, decision point 646 searches to find whether a second user has opted out for the detected flash sale. If the Yes decision is taken at decision point 646, the method may, in one embodiment, negatively adjust the second user's ranking based on the opt-out, or may simply proceed to decision point 648. At decision point 648, the method 601 continues to check to determine whether the second user tries to re-opt-in. If the Yes decision is taken at decision point 648, the rank of the user may be positively adjusted based on the opt-in in one embodiment (not shown in FIG. 6B). In any event, at step 650 the first user may be sent a notification to allow the first user to take part in the flash sale instead of allowing the second player to re-opt-in. While the above method 601 has been disclosed with respect to a single first user, those of ordinary skill in the art will understand that the method 601 may be operated with respect to a plurality of first users.

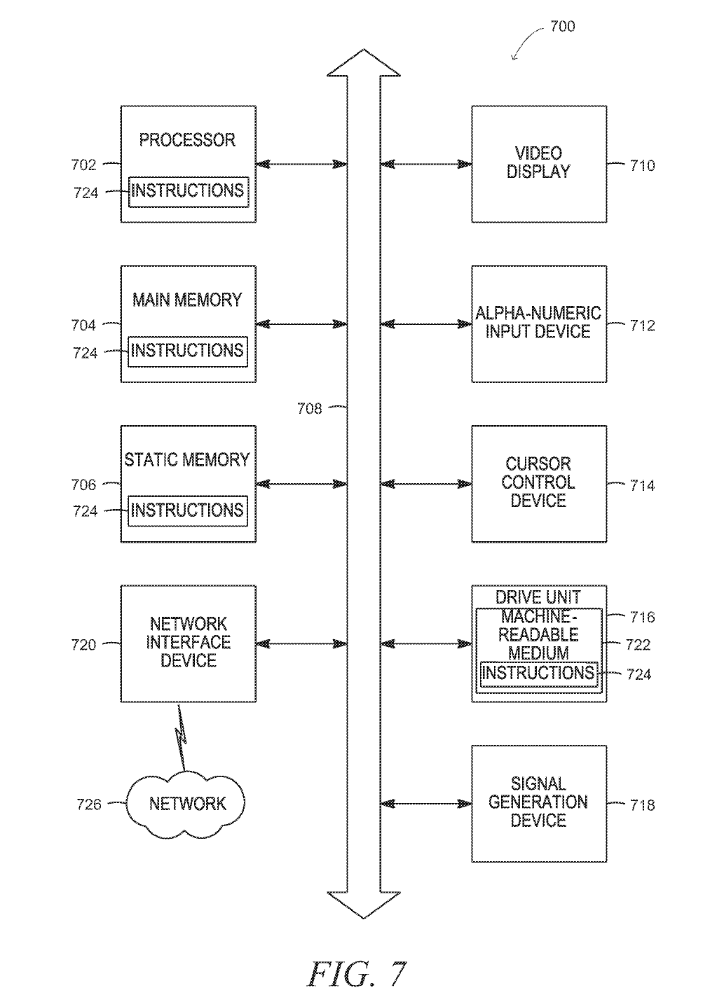

FIG. 7 shows a diagrammatic representation of a machine in the example form of a computer system 700 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions 724 (e.g., software) embodying any one or more of the methodologies or functions discussed herein. The instructions 724 may also reside, completely or at least partially, within the main memory 704 and/or within the processor 702 during execution thereof by the computer system 700, the main memory 704 and the processor 702 also constituting machine-readable media.

The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions 724. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Thus, a method and system to browse an electronic marketplace, place items of interest into a shopping cart, selectively purchase one or more items in the shopping cart without having to remove the non-selected items from the shopping cart, and automatically retain the non-selected items in the shopping cart for future access has been discussed. Although the embodiments of the present subject matter have been discussed with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. Further, as used herein, the term “or” may be construed in either an inclusive or exclusive sense. Similarly, the term “exemplary” is construed merely to mean an example of something or an exemplar and not necessarily a preferred or ideal means of accomplishing a goal.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method in an electronic publication system, the method comprising:
receiving, at a processor of a machine, identities of a plurality of users that register to be notified when a flash sale occurs;
ranking the identities of the plurality of users in a ranked queue;
detecting one of the plurality of users purchasing a product in the flash sale; and
based on the purchasing, improving a rank of the one of the plurality of users in the ranked queue.

2. The method of claim 1, further comprising receiving profiles that indicate product preferences of the plurality of users.

3. The method of claim 1, further comprising notifying a set of the plurality of users based on the ranks of the identity of the plurality of users in the ranked queue.

4. The method of claim 1, further comprising placing a first one of the plurality of users higher in the ranked queue based on a second one of the plurality of users opting out of the flash sale.

5. The method of claim 1, further comprising ranking individual ones of the identities in the ranked queue based on a time at which the respective ones of the plurality of users associated with the identities registered.

6. The method of claim 1, further including determining inventory for the flash sale by comparing user product preferences to inventory.

7. The method of claim 1, further including creating a limited flash sale and notifying users based on a particular rank in the ranked queue.

8. The method of claim 1, wherein the rank of an identity of a user is decreased based on the one of the plurality of users opting-out of the flash sale.

9. The method of claim 1, further including computing a time period during which a user is given an option of opting-out.

10. The method of claim 9, wherein the time period is variable based on product demand.

11. The method of claim 1, further including computing a product discount.

12. The method of claim 11 wherein a value of the product discount is variable based on the rank of the one of the plurality of users.

13. A machine-readable storage device having embedded therein a set of instructions which, when executed by a machine, causes the machine to execute operations comprising:
receiving identities of a plurality of users that register to be notified when a flash sale occurs;
ranking the identities of the plurality of users in a ranked queue;
detecting one of the plurality of users purchasing a product in the flash sale; and
based on the purchasing, improving a rank of the identity of the one of the plurality of users in the ranked queue.

14. The machine-readable storage device of claim 13 the operations further comprising receiving profiles that indicate product preferences of the plurality of users.

15. The machine-readable storage device of claim 13 the operations further comprising notifying a set of the plurality of users based on the rank of the identity of the user in the ranked queue.

16. The machine-readable storage device of claim 13 the operations further comprising ranking a first one of the plurality of users higher in the ranked queue based on a second one of the plurality of users opting out of the flash sale.

17. The machine-readable storage device of claim 13, wherein individual ones of the identities are ranked in the ranked queue based on the time at which the respective ones of the plurality of users associated with the identities registered.

18. The machine-readable storage device of claim 13 the operations further including determining inventory for the flash sale by comparing user product preferences to inventory.

19. The machine-readable storage device of claim 13 the operations further including creating a limited flash sale and notifying users based on a particular rank in the ranked queue.

20. The machine-readable storage device of claim 13 wherein a rank of an identity of a user is decreased based on one of the plurality of users opting-out of the flash sale.

21. The machine-readable storage device of claim 13 the operations further including computing a time period during which a user is given an option of opting-out.

22. The machine-readable storage device of claim 21 wherein the time period is variable based on product demand.

23. The machine-readable storage device of claim 13 the operations further including computing a product discount.

24. The machine-readable storage device of claim 23 wherein the value of the product discount is variable based on the rank of the identity of one of the plurality of users.

25. A networked publication system comprising:
one or more computer processors and storage configured to receive identities of a plurality of users that register to be notified when a flash sale occurs;
components of one or more computer processors and storage configured to record the identities of the plurality of users in a ranked queue;
components of the one or more computer processors and storage configured to detect one of the plurality of users purchasing a product in the flash sale; and
components of the one or more computer processors and storage configured to, based on the purchasing, improve the rank of the one of the plurality of users in the ranked queue.
